(19) United States
(12) Patent Application Publication
(10) Pub. No.: US 2007/0120523 A1
(43) Pub. Date: May 31, 2007

(54) POWER SUPPLY FOR ELECTROCHEMICAL ION EXCHANGE CELL

(75) Inventors: James HOLMES, San Carlos, CA (US); Joe Evans, Palo Alto, CA (US); Eric Nyberg, Belmont, CA (US)

Correspondence Address: JANAH & ASSOCIATES A PROFESSIONAL CORP, 650 DELANCEY STREET, SUITE 106, SAN FRANCISCO, CA, 941072001, US

(73) Assignee: Pionetics Corporation

(21) Appl. No.: 11/552,068

(22) Filed: Oct. 23, 2006

Related U.S. Application Data
(63) Continuation-in-part of application No. 11/024,521, filed on Dec. 28, 2004.

(51) Int. Cl. H02J 7/00

(52) U.S. Cl. 320/103

(57) ABSTRACT

An electrode power supply for an electrochemical ion exchange cell having an ion exchange membrane between a pair of electrodes, has a voltage selector to receive an AC voltage and selectively couple the AC voltage to a voltage supply. The voltage supply produces an output voltage from the AC voltage. A zero crossing detector detects zero-crossing events in the AC voltage and produce an indication related to the zero-crossing events. The selective coupling of the voltage selector is enabled based on the indication of the zero-crossing events.

### CROSS-REFERENCE TO RELATED APPLICATIONS

The present application is a continuation-in-part of U.S. patent application Ser. No. 11/024,521, to Holmes et al., filed Dec. 28, 2004, entitled “Power Supply for Electrochemical Ion Exchange,” and which is hereby incorporated by reference in its entirety.

### BACKGROUND

Embodiments of the invention relate to a power supply for an electrochemical ion exchange cell.

A fluid treatment apparatus comprises one or more electrochemical ion exchange cells and is used to replace or add ions to a fluid, remove particles and sediment, and deactivate or reduce the levels of microorganisms in the fluid. The electrochemical cells are used to treat water, and other fluids, such as solvent or oil based fluids, chemical slurries, and waste water. The cell removes or replaces ions in a fluid stream, for example, to produce purified water by deionization, treat waste water, or selectively substitute ions in a fluid. A typical cell comprises electrodes about an ion exchange material which removes or replaces ions in an influent solution to form a treated solution. After the cell is used for some time, the ion exchange material is regenerated by reversing the polarity of the voltage applied to the electrodes. The ion exchange material may be a water-splitting ion exchange membrane (also known as a bipolar, double, or laminar membrane) that is positioned between two facing electrodes, as for example, described in commonly assigned U.S. Pat. No. 5,788,826 to Nyberg, issued Aug. 4, 1998, U.S. patent application Ser. No. 10/637,186 to Holmes et al., filed Aug. 8, 2003, and U.S. patent application Ser. No. 10/900,256 to Hawkins et al., filed Jul. 26, 2004, all of which are incorporated herein by reference in their entireties. Electrochemical ion exchange cells are advantageous because they can be used to efficiently treat an influent solution and are easier to regenerate than chemical cells which require chemicals for regeneration.

A power supply is used to apply cell deionization and regeneration voltages to the electrodes of the electrochemical cell. The power supply provides a relatively high voltage to the electrodes and also controls the polarity of the voltage. The voltage level is related to the effectiveness of the electrochemical cell at removing or replacing ions, and the polarity is switched to select de-ionization or regeneration of the cell. As there may be a tendency for the current delivered to the cells to increase beyond desirable limits, due to, for example, an electrical short or a transient low resistance pathway it is also desirable for the power supply to monitor and limit the current supplied to the electrodes. Furthermore, the power supply should also be cost and energy efficient, as ion exchange apparatuses are often used for fluid treatment in economically-developing product markets.

Power supplies have been developed for use with ion exchange apparatuses. For example, U.S. Pat. No. 5,055,170 to Saito, issued Oct. 8, 1991, which is incorporated herein by reference in its entirety, discloses a circuit for applying a DC voltage between electrodes in an electrolytic cell having an ion-exchange membrane. The circuit has a transformer to step down an AC voltage, which is then rectified and supplied to the collector of an NPN transistor whose emitter is connected to the positive electrode of the electrolytic cell. The base of the NPN transistor is driven by a control circuit which receives an input based on a measured voltage drop in the cell. However, there are disadvantages of this circuit, for example the output DC voltage is limited in value to the voltage level of the rectified stepped down voltage. Thus, the output DC voltage will never be greater in value than the amplitude of the available AC voltage. Furthermore, the use of a transformer in the circuit driving the electrodes may be undesirable due to the potentially high cost and weight of such a component. Additionally, Saito provides no means to monitor and limit the current delivered to the electrode.

In another example, U.S. Pat. No. 4,012,310 to Clark et al., which is incorporated herein by reference in its entirety, discloses a high voltage supply for an electrode of an electrostatic water treatment system. The high voltage supply of Clark et al. comprises a DC multiplier having a center-tapped transformer fed by a transistor oscillator and a DC power supply. The action of the transistor oscillator serves to turn the multiplier on and off to conserve energy, resulting in the charging and discharging of a capacitance between the electrode and a shell around the electrode. However, the use of a transformer, as in the circuit of Saito, is undesirable. The high voltage supply of Clark et al. also has an over current protection which turns off the high voltage supply in the event of an excessive current delivered to the electrode. However, it is undesirable to completely shut down the power delivery to the electrostatic water treatment system, as a complete shutdown will incur an undesirable transient startup time to begin water treatment after the shutdown. Furthermore, the high voltage supply of Clark et al. does not generate a DC voltage which has a selectable voltage level.

Another problem is that electrode power supplies typically require the use of components that are rated to withstand the full value of the voltage generated by the power supply. However, as the power supply becomes capable of producing relatively higher voltage levels, the components are required to be rated for these higher voltages which increase their cost of fabrication. Thus, the benefit of an electrode power supply to deliver a relatively higher output voltage is usually offset by the cost of the components of such a power supply.

During cell deionization and regeneration, a power supply is used to apply the requisite voltage to the electrodes of the cell. The power supply should allow effective control of polarity for de-ionization or regeneration and voltage levels. It is also desirable for the power supply to monitor and limit the current supplied to the electrodes as the current delivered to the cells can increase beyond desirable limits due to a transient low resistance pathway. Furthermore, the power supply should also be cost and energy efficient, as fluid treatment cells are often used for drinking water applications in economically-developing markets. Thus, it is desirable to have a power supply for an ion exchange apparatus capable of delivering a DC voltage having a relatively selectable polarity and voltage levels, which can limit the current supplied to the electrodes, and that is energy efficient and relatively inexpensive.

### DRAWINGS

These features, aspects and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a schematic view of an embodiment of a ion exchange apparatus comprising an electrochemical cell having electrodes positioned about membranes;

FIG. 2A is a schematic sectional top view of the electrochemical cell of FIG. 1 showing a cartridge having membranes with integral spacers that are spirally wound around a core tube;

FIG. 2B is a schematic partial sectional perspective exploded view of an embodiment of an electrochemical cell having membranes wrapped around tubular electrodes which can apply an electric potential in the cell;

FIG. 3 is a schematic diagram of an embodiment of a ion exchange apparatus which has dual electrochemical cells and dual power supplies, a solenoid valve system and various filters;

FIG. 4 is a schematic diagram of a controller comprising a control unit, power supply and supplemental power supply;

FIG. 5 is a schematic diagram of an electrode power supply;

FIG. 6 is a schematic diagram of a voltage selector of the electrode power supply of FIG. 5;

FIG. 7A-C are schematic diagrams of different versions of zero crossing detectors suitable for use in the electrode power supply of FIG. 5;

FIG. 7D is an integrated zero crossing detector and polarity selector; and

FIG. 8 is a schematic view of a current detector appropriate for use in the power supply of FIG. 5.

### DESCRIPTION

Embodiments of the present invention may be utilized as a component of systems and apparatus capable of treating a fluid to extract, replace or add ions to the fluid, remove particles and sediment, and deactivate or reduce the levels of microorganisms in the fluid. While exemplary embodiments of the ion exchange apparatus are provided to illustrate the invention, they should not be used to limit the scope of the invention. For example, the ion exchange apparatus can include an apparatus other than the electrochemical cells or cell arrangements described herein, as would be apparent to those of ordinary skill in the art. Also, in addition to the treatment of water, which is described as an exemplary embodiment herein, the ion exchange apparatus can be used to treat other fluids, such as solvent or oil based fluids, chemical slurries, and waste water. Thus, the illustrative embodiments described herein should not be used to limit the scope of the present invention.

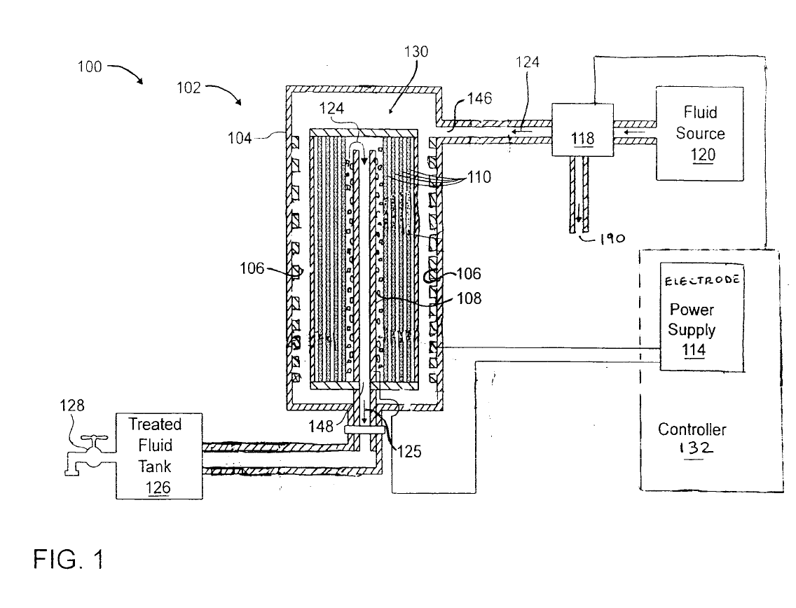

An exemplary embodiment of an apparatus 100 capable of treating a fluid by ion exchange is shown in FIG. 1. The apparatus 100 comprises an electrochemical cell 102, which includes a housing 104 enclosing at least two electrodes 106, 108 and one or more ion exchange membranes 110, such as water-splitting ion exchange membranes. A controller 132 comprising a cell power supply 114 and other control elements controls the power supplied to the cell 102 and controls the valve system 118. The cell power supply 114 is provided to power the electrodes 106,108 by supplying a current or voltage to the electrodes 106,108. The valve system 118 controls the fluid supply from a fluid source 120 to provide an influent fluid stream 124 into the cell. The treated fluid is passed out of the cell 102 as a treated or effluent fluid stream 125 which may be stored in a treated fluid tank 126 and/or released from a dispensing device 128. Electrochemical ion exchange apparatuses are described in commonly assigned U.S. Pat. No. 5,788,812 issued to Nyberg et al., U.S. patent application Ser. No. 10/130,256 also to Nyberg et al.; and U.S. patent application Ser. No. 11/021,931 to Holmes et al., all of which are incorporated herein by reference in their entireties.

The electrodes 106,108 of the cell 102 are fabricated from electrically conductive materials, such as a metal, metal alloy, or carbon which are resistant to corrosion in the low or high pH chemical environments formed during the positive and negative polarization of the electrodes 106,108, in operation of the cell 102. Suitable electrodes 106,108 can be fabricated from corrosion-resistant materials such as titanium or niobium, and can have an outer coating of a noble metal, such as platinum. The shape of the electrodes 106, 108 depends upon the design of the electrochemical cell 102 and the conductivity of the fluid stream 124 flowing through the cell 102. Suitable shapes for the electrodes 106,108 include for example, wires, wire mesh wraps and sheets with punched holes. The electrodes 106,108 are arranged to provide an electric potential drop through the membranes 110 upon application of a current to the electrodes 106,108.

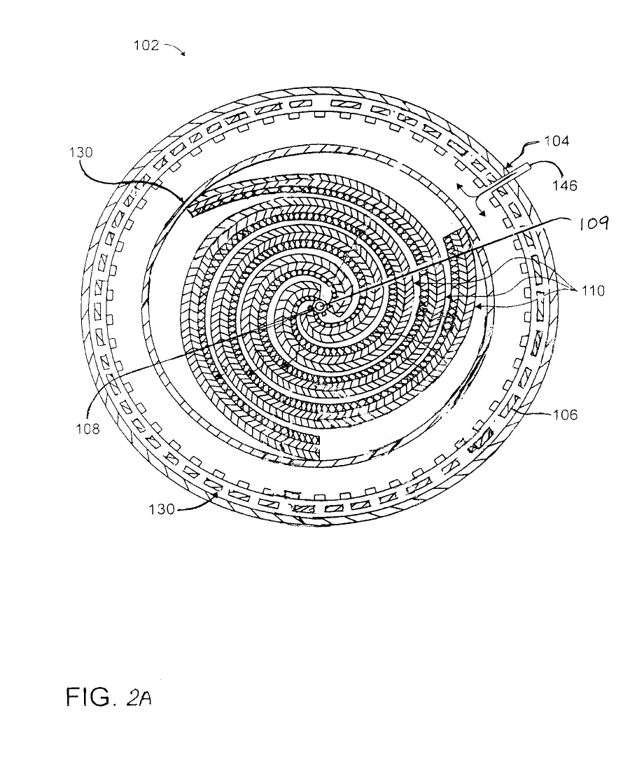

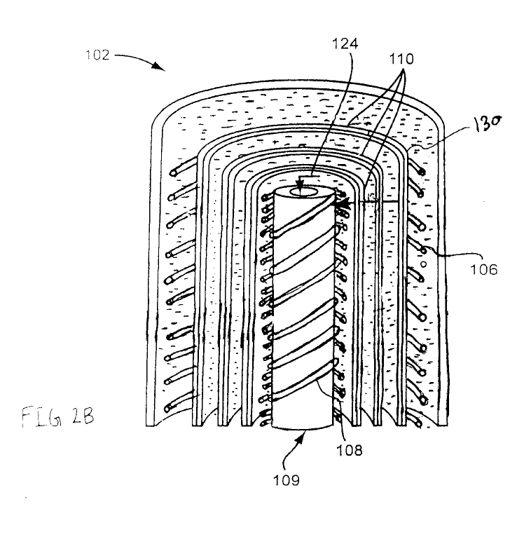

In one version, shown in FIGS. 2A and 2B, the cell 102 comprises a cartridge 130 containing a pair of electrodes 106,108, which are wires wrapped on a central riser tube 109 in the center of the cartridge 130 and the wire wrap outside the cartridge adjacent to the inner wall of the housing 104. The electrodes are located about a stack of spiral wrapped water splitting membranes 110 which are rolled and bound together by an outer netting tube (not shown). In the cell 102, the fluid stream 124 flows between the membrane layers from the outside to the inside of the housing 104, and into the top of riser tube 109, and exits at the bottom of the cell 102, or fluid flow may be in the opposite direction. The electric potential difference is applied between the two electrodes 106,108, across the stack of spirally wound membranes 110. Advantageously, the cartridge 130 provides a high density or packing efficiency of stacked membranes 110 between the two electrodes 106,108 in a smaller footprint, and also allows easy replacement or cleaning of membranes 110 by changing the cartridge 130.

The electrodes 106,108 can also have other shapes, such as concentric spheres, parallel plates, tubular wire meshes, discs, or even conical shapes, depending on the application. For example, a parallel plate cell comprising a pair of electrodes that are parallel plates on either side of a water-splitting membrane 110. Instead of one membrane 110, a plurality of stacked membranes 110 can also be used in this cell. In the parallel plate cell, the fluid stream 124 flows perpendicular to and through, or between the surfaces of, the membranes 110. As another example, a disc cell, comprises a pair of electrodes comprising discs on either side of a stack of water-splitting membranes 110. In the disc cell, the fluid stream 124 flows through the membranes 110 and is assisted by gravity. The electric potential drop is applied between the two disc electrodes. The membranes 110 are also shaped as circular discs and can also have separators (not shown) between them.

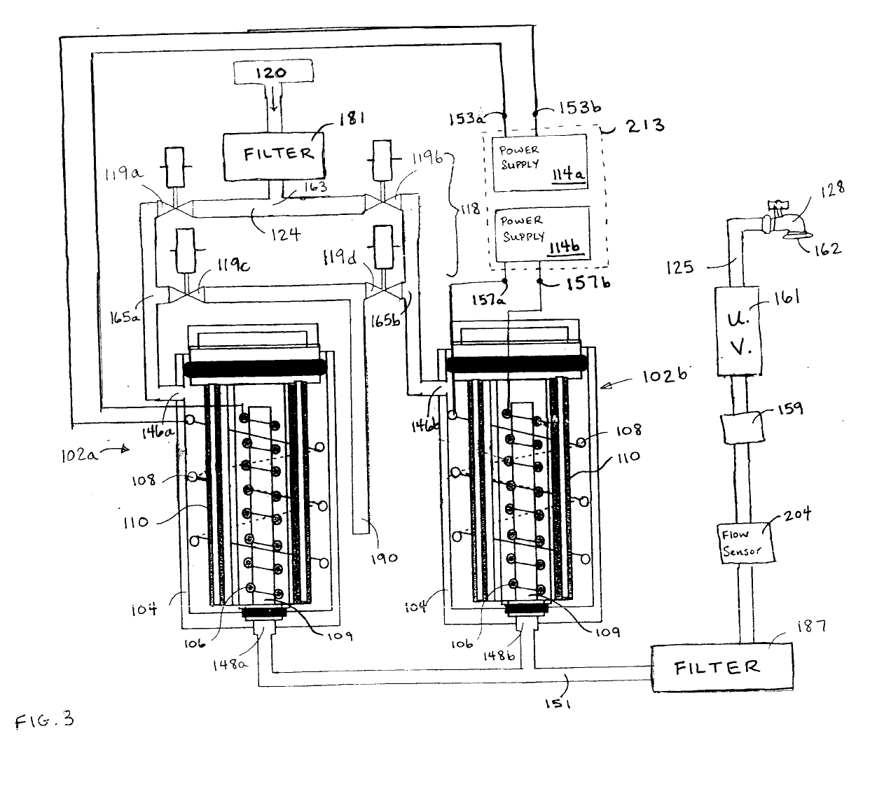

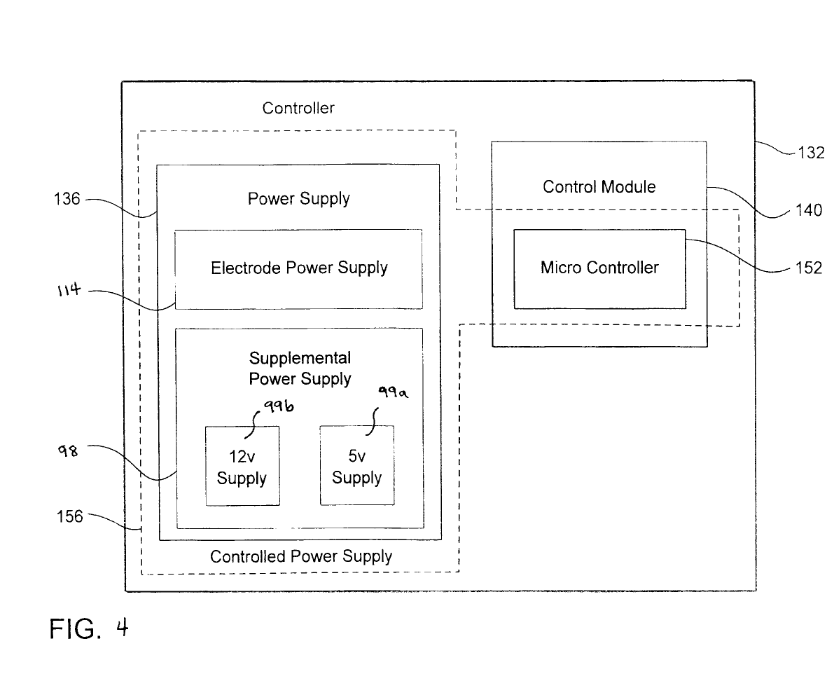

The electrochemical ion exchange apparatus 100 comprises a controller 132 which controls the operation of the apparatus 100 and supplies control signals and power to components of the apparatus 100. The controller 132 illustrated schematically in FIG. 4 comprises an electrode power supply 114, a supplemental power supply 98, and a control module 140. The power supplies 114,98 are capable of generating voltages having selectable level and polarity to deliver power to components of the electrochemical ion exchange apparatus 100. The voltage levels generated are controlled by the controller and depend on the component requirements, the operating conditions of the apparatus 100, or other factors. For example, the electrode power supply 114 is used to generate a relatively high voltage to deliver power to the electrodes 106,108 of the electrochemical ion exchange cell 102 while the supplemental power supply 98 is used to generate relatively low voltages to deliver power to components such as the solenoids or motors of the valve system 118, components of the controller 132, and other components in the electrochemical ion exchange apparatus 100 requiring power.

The control module 140 is capable of generating and receiving signals and instructions to individually and collectively operate components of the electrochemical ion exchange apparatus 100. The control module 140 comprises electronic circuitry and program code to receive, evaluate, and send signals. In one version, the control module 140 comprises a microcontroller 152 which is typically a single integrated circuit device that comprises several of the components of the control module 140. For example, the microcontroller 152 may comprise a CPU, memory, program code, input and output circuitry, and other circuitry that may be specialized or adapted to particular tasks. The microcontroller 152 is advantageous because it encapsulates a relatively high degree of functionality into a single programmable component. One example of suitable commercially available microcontrollers 152 are the PICmicro® series of microcontrollers, such as for example the 28/40-Pin 8-Bit CMOS Flash PIC16F87X Microcontroller, available from Microchip located in Chandler, Ariz. Another example of a suitable commercially available microcontroller 152 is the 68000 available from Motorola Corp., Phoenix, Ariz. There are many other microcontrollers and microprocessors that can be used as the microcontroller 152, as would be apparent to one versed in the art.

In one version, the power supply 136 and a portion of the control module 140, such as the microcontroller 152, can together form a controlled power supply 156. The controlled power supply 156 combines the generation of voltages and current to deliver power to the components of the ion exchange apparatus with the programmability and control functionality of the microcontroller 152. The controlled power supply 156 may also be part of a controller 132 having a control module 140 and other components besides the microcontroller 152.

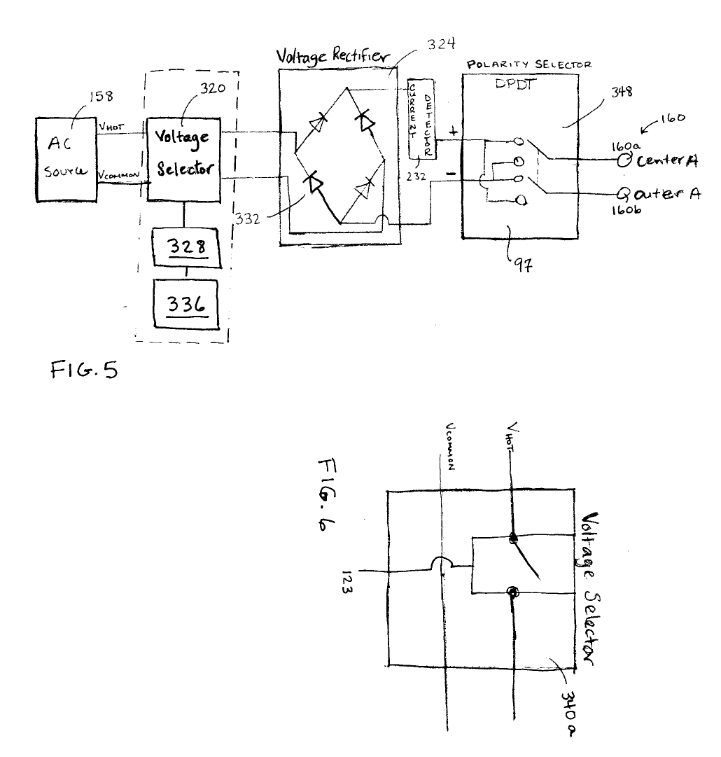

The electrode power supply 114 depicted in FIG. 5 comprises a voltage selector 320 to receive the AC voltage and selectively couple the AC voltage to a rectified voltage supply 324. The voltage selector 320 selectively couples the AC voltage by segmenting the voltage signal into pre-selected portions, for example, the entire positive component of a sinusoidal signal trace, or a portion of the positive component, such as a ¼ wavelength of the entire sinusoidal signal that has a positive value higher than zero, or a ½ wavelength, or other such portions. The voltage selector 320 switches the electrode power supply 114 between an on state and an off state based on a control input received from a control input source 328. In one version, the control input source 328 is a human operator of the ion exchange apparatus 100. In another embodiment, the control input source 328 is a controller such as the microcontroller 152, and the control input is optionally an automated control input. The control input can comprise a control input signal.

The electrode power supply 114 comprises one or more output terminals 160. In the on state, the electrode power supply 114 supplies the output voltage, produced by the rectified voltage supply 324 from the AC voltage to at least one of the output terminals 160 of the electrode power supply 114. In the off state, the electrode power supply 114 does not supply the output voltage to the output terminals 160. In one version (not shown), the output terminal 160 comprises a single output terminal. In this version, the voltage at the output terminal is referenced to ground and the circuit is completed through ground. In one version, the output terminals 160 comprise a pair of terminals 160a,b. One of the terminals 160 comprises an electrically hot terminal and the other of the terminals 160 comprises a grounded terminal, wherein the grounded terminal is electrically connected to the common ground. In this version, the voltage output by the power supply comprises both the voltage between the terminals 160a,b and has a magnitude equal to the magnitude of the voltage between the electrically hot terminal and ground. In another version, the output terminals 160 comprise a positive electrically hot terminal and a negative electrically hot terminal. In this version, the voltage output by the power supply comprises the voltage between the terminals 160c,d. When the power supply is in the on state, the positive electrically hot terminal has a voltage that is positive relative to ground and the negative electrically hot terminal has a voltage that is negative relative to ground.

The electrode power supply 114 comprises the rectified voltage supply 324 to produce the output voltage from the selectively coupled AC voltage. The output voltage produced by the rectified voltage supply 324 comprises a non-zero pulsating DC component. That is, the voltage output by the rectified voltage supply 324 comprises a DC voltage that can vary from about +1.2 volts to a peak of about +320V and back down to +1.2 V. The DC output voltage comprises a DC component that pulses at a frequency that is related to the input frequency and can have a maximum of twice the input frequency. For an input AC frequency of about 60 Hz, the DC output voltage comprises a DC component having a maximum frequency of about 120 Hz. For an input AC frequency of about 50 Hz, the DC output voltage comprises a DC component that can have a maximum frequency of about 100 Hz. While the output voltage does vary as a function of time, it is described as DC because the polarity of the output voltage is constant over many periods of oscillation. For example, the voltage output by the rectified voltage supply can comprise a full-wave rectified version of the AC voltage.

The rectified voltage supply 324 shown in FIG. 5 is a diode-bridge full-wave rectifier 328 and comprises a plurality of diodes 332 in a diode-bridge arrangement. The rectified voltage supply 324 produces an output voltage comprising the full-wave rectified version of the portion of the AC voltage allowed to pass through the voltage selector 320 and may comprise a full-wave version of the AC voltage, or may comprise rectified segments of the AC voltage. The rectified voltage supply 324 can comprise other elements, such as other kinds of diodes, or diodes used with capacitors.

The rectified voltage supply 324 can comprise other components or arrangements for example the rectified voltage supply can comprise capacitors and diodes. In one exemplary embodiment, the rectified voltage supply 324 comprises two diodes that are connected to the input, one able to pass current from the input and the other able to pass current into the input. The ends of the diodes are attached to two capacitors (capacitor 1 and capacitor 2), and the ends of the capacitors are connected to the neutral pin of the AC input. The output voltage is taken to include both capacitors between it's pins. When the input signal is a positive voltage pulse, current flows through the forward diode, onto capacitors and out of the neutral AC pin, charging capacitors. When the input signal is a negative voltage pulse, current flows through the reverse diode, off of the capacitor 2 and out of the neutral AC pin, thereby charging capacitor 2. If the circuit is run with a power input that is higher than it's power output, the capacitors will be charged to give a combined output voltage of twice the voltage magnitude of the chopped AC input signal. If necessary, the voltage can be stepped up further by applying the output of the voltage multiplier to another pair of capacitors, however, the current available is limited by the input power rating of the rectifier.

In one embodiment, the voltage selector 320 is enabled to perform the selective coupling based on zero-crossing events in the AC voltage. That is, the selective coupling functionality of the voltage selector 320 in such embodiments is either enabled or disabled in relation to the zero-crossing events. When the selective coupling functionality is enabled, the voltage selector 320 can couple or decouple the AC voltage to the rectified voltage supply 324. When the selective coupling is disabled, the voltage selector 320 can not change the coupled or decoupled status of the AC voltage relative to the rectified voltage supply 324. The enabling of the coupling functionality of the voltage selector 320 serves to reduce electromagnetic noise and interference, increase the expected operational lifetime of the electrode power supply 114, and provides a degree of safety of the operation of the electrode power supply 114. The voltage selector's coupling functionality is enabled within a predetermined AC voltage level or time increment relative to zero-crossing events in the AC voltage. For example, the voltage selector 320 optionally is enabled to selectively couple the AC voltage to the rectified voltage supply 324 based on a comparison of a voltage level of the AC voltage with a predetermined voltage level.

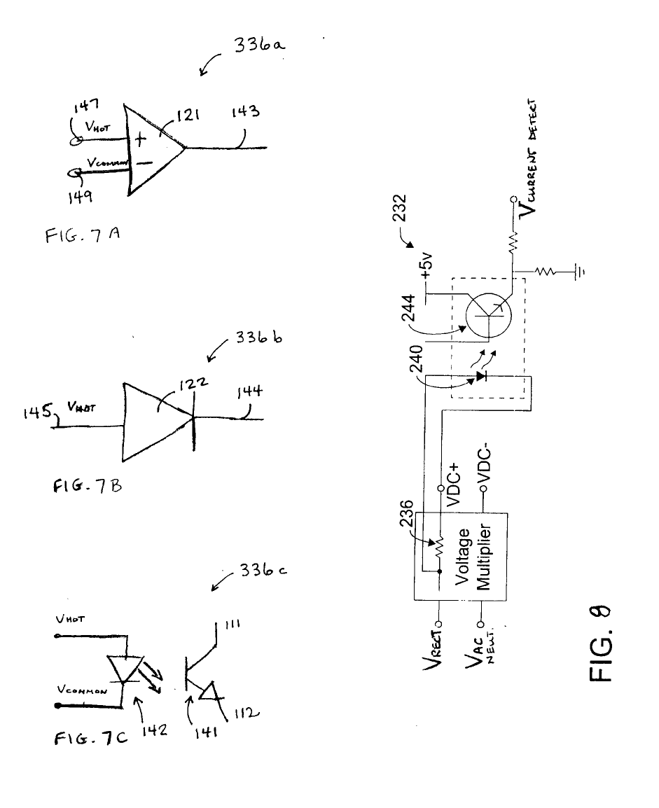

The electrode power supply 114 also comprises a current detector 232 to detect the current level delivered to electrodes 106,108 in association with the DC voltage, and generate a current detection signal in relation to the detected current level. An exemplary embodiment of a current detector 232 is shown in FIG. 8 and comprises a sense resistor 236, a light-emitting diode (LED) 240 connected across the sense resistor 236, and a photo-transistor 244 optically coupled to the LED 240. The sense resistor 236 is arranged in series with one node of the DC voltage delivered to the output terminals 160, and may coincide with a series output resistor used by the DC voltage supply 164 for similar or alternative purposes. The sense resistor 236 is able to hold its resistance stable under a wide range of voltage, current or temperature conditions. In one version, the sense resistor 236 has a value of from about 0.1 Ohms to about 10 Ohms, and a suitable value is 1 Ohm. The current level running through the sense resistor 236 is coupled to the photo-transistor 244, which is in a common-collector or emitter-follower configuration, to generate the current detection signal at the node V_{CURRENT DETECT}. In one version, the current detector 232 generates the current detection signal and the control module 140 is capable of receiving the current detection signal. For example, the controller 132 may comprise a controlled power supply 156 in which the current detector 232 generates the current detection signal and the microcontroller 152 is capable of receiving the current detection signal.

The electrode power supply 114 comprises a zero crossing detector 336 to detect zero-crossing events in the AC voltage and produce an indication related to the zero-crossing events. The voltage selector 320 is enabled to selectively couple the AC voltage to the rectified voltage supply 324 based on the indication. In one embodiment, the indication comprises an indication signal produced by the zero-crossing detector 336. The indication signal can have a variety of formats. For example, the indication signal can comprise a relatively high voltage level when there is no zero-crossing event in the AC voltage and a relatively low voltage level when there is a zero-crossing event in the AC voltage. Or, the indication signal can comprise a pulse train with the pulses located at the zero-crossing events. Or, the indication signal can comprise a square wave with the higher voltage portion of the square wave located at the zero-crossing events. Or, the indication signal can comprise a relatively low voltage level when there is no zero-crossing event in the AC voltage and a relatively high voltage level when there is a zero-crossing event in the AC voltage. Other embodiments of the indication signal are also possible, including embodiments having at least one of: inverted voltage pulses, inverted square waves, or modulated signals.

In one embodiment, depicted in FIG. 7B, the zero-crossing detector 336b comprises a component device consisting of a diode 122. The diode allows current to pass between the diode input 145 and the diode output 144 terminals when the voltage applied between its input 145 and output 144 terminals is of the correct polarity and above the diode's threshold conduction voltage. In one version the diode 122 allows current to pass when the voltage applied between its terminals is above +1.5 volts. When the voltage applied between the terminals of the diode 122 falls below about +1.5 volts, the diode 122 switches from on to off and prevents the flow of current. The diode 122 switches from off to on or from on to off when the voltage of the AC source 158 passes through about +1.5 volts. For an AC source 158 having a frequency of about 60 Hz, the diode 122 switches at about 1/120 second intervals, or every time the AC source 158 passes through about +1.5 volts. The output from the zero-crossing detector 336a comprises an alternating voltage with varying portions and low portions, the varying portions corresponding to the portions of the AC source 158 voltage having a value of greater than the threshold value of about +1.5 volts and the low portions having a value of about zero volts. The output of the zero-crossing detector 336b resembles a half-wave rectified version of the AC source 158 voltage and zero-crossing events are indicated by the beginning and ending of each half wave positive component of the output signal. Diodes having other threshold voltages can be used, as would be apparent to one versed in the art.

In another embodiment, as depicted in FIG. 7A, the zero-crossing detector 336a is an integrated circuit comprising a comparator 121. The comparator 121 detects when the voltage across its pins 147,149 changes polarity. The output of the comparator 121 is comparatively high when the voltage on its first pin 147 is more positive than the voltage on its second pin 149, and comparatively low when the voltage on the first pin 147 is less positive than that on the second pin 149. For example, the comparator 121 may output a voltage of about 12 volts when the voltage at the first pin 147 is more positive than the voltage at the second pin 149, and a voltage of 0.2 volts when the voltage at the first pin 147 is less positive than the voltage at the second pin 149. Thus, the comparator output comprises a square wave and zero crossing events are indicated by the edges of the square waves, that is, the portions of the signal comprising a step up or step down. The comparator can be supplied with a DC voltage from the supplemental power supply, wherein the comparatively high voltage value output by the comparator 121 is about the value of the voltage supplied to the comparator 121 by the supplemental power supply. Comparators having some other values of voltage output can be used, as would be apparent to one versed in the art.

In another embodiment, as depicted in FIG. 7C, the zero crossing detector 336c comprises an LED 142 and a phototransistor 141 which are optically coupled together. In the on state, the phototransistor 141 conducts between the input and output terminals 111, 112, and in the off state the phototransistor 141 substantially does not conduct between the input and output terminals 111, 112. When the LED 142 is on, the light triggers the light sensitive phototransistor 141 which then is conducting. The LED 142 trigger characteristics are substantially similar to those of a standard diode, that is, the LED 142 is in the non-emitting state when the voltage between it's input and output terminals is less than a threshold value and is in the on or emitting state when the voltage between it's input and output terminals is higher than the threshold value. In one version, the threshold voltage of the LED 142 is about +1.5 volts however other LEDs having other threshold values can be used, as would be apparent to one versed in the art. The output from the zero-crossing detector 336c depends on the connection of the phototransistor terminals 111,112. When a DC voltage is applied between the terminals 111, 112 the output of the zero-crossing detector 336c comprises a square wave voltage signal. Alternately, the output signal can comprise a current signal, that is, components of the controller 132 or microcontroller 152 can be connected to the zero crossing detector 336c output circuit and receive an indication of the zero crossing event by sensing the flow of current through the device.

In one embodiment, the voltage selector 320 comprises a relay 340 to receive the voltage of the AC source 158 and selectively couple the AC voltage to the rectified voltage supply 324. In the embodiment shown in FIG. 6 the relay 340 comprises a single-pole, single-throw semiconductor switch 340a. The semiconductor switch 340a regulates current flow through a junction, much like a transistor, and can be switched on or off by applying a voltage at the gate pin 123. The semiconductor switch 340a is used to turn the AC power supplied to the voltage rectifier 324 on and off. In one embodiment, the semiconductor switch 340a is operated by the zero crossing detector 336 such that it switches on or off in relation to zero crossing events of the input AC voltage. In another embodiment, the semiconductor switch 340a is operated by the controller 132 which delivers a signal to the semiconductor switch 340a in relation to the zero-crossing detector signal and also inputs from other portions of the apparatus 100 such as the current detector 232, or an on-off switch operated by a user. In other embodiments, the relay 340 comprises a single-pole single-throw mechanical relay or a double-pole double-throw semiconductor or electro-mechanical relay.

In one embodiment, the zero-crossing detector 336 is integrated with the voltage selector 320. In this embodiment, the voltage selector 320 and zero-crossing detector 336 comprise a single discrete component (not shown). In such an embodiment, the indication signal generated by the zero-crossing detector 336 may be a signal internal to the integrated voltage selector and zero-crossing detector 336.

In one embodiment, when the voltage of the AC source 158 is coupled to the rectified voltage supply 324, i.e., when the electrode power supply 114 is selected to be in the on state, the output voltage produced from the AC voltage is supplied between the output terminals 160a,b. The electrode power supply 114 comprises at least one pair of output terminals 160a,b, and when the electrode power supply 114 is selected to be in the on state, the output voltage is supplied between the pair of output terminals 160. When the voltage selector 320 does not couple the AC voltage to the rectified voltage supply 324, i.e., when the electrode power supply 114 is selected to be in the off state, the voltage supplied to the output terminals 160a,b by the power supply 114 comprises at least one of: a substantially zero voltage, or a floating voltage.

The electrode power supply 114 shown in FIG. 5 comprises a polarity selector 348 to select the polarity of the output voltage relative to the electrochemical ion exchange cell 102. The polarity selector 348 provides at least one of the following functions: selecting the polarity of the output voltage to the output terminals 160a,b, or selectively coupling the output terminals 160a,b to the electrodes 106,108 of the electrochemical ion exchange cell 102. The polarity selector 348 is controlled by the controller 132 and selects the polarity of the output voltage at the output terminals 160 of the electrode power supply 114. For example, the polarity selector 348 can be used to select the polarity of the output voltage delivered to the electrodes 106,108 of an electrochemical ion exchange cell 102. In such an embodiment, the polarity selector 348 can be used to select the polarity of the output voltage supplied to the at least one electrochemical ion exchange cell 102. In one mode of operation, the polarity selector 348 can select a positive output voltage polarity at the output terminals 160a,b to provide a positive voltage between the electrodes 106,108 of the at least one electrochemical ion exchange cell 102 to enable the cell 102 to operate in the regeneration mode. In another mode of operation, the polarity selector 348 can select a negative output voltage polarity at the output terminal 160 to provide a negative voltage between the electrodes 106,108 thus enabling the cell 102 to operate in de-ionization mode.

The polarity selector 348 is controlled by the control module 140 and selectively couples the output terminals 160a,b of the electrode power supply 114 to the electrodes 106,108 of the electrochemical ion exchange cell 102. For example, in one version, the ion exchange apparatus 100 comprises at least one electrode power supply 114 and a plurality of electrochemical cells 102 including at least a first electrochemical ion exchange cell 102a used for fluid treatment and a second electrochemical ion exchange cell 102b operated in regeneration. In such an embodiment, the polarity selector 348 can be used to provide a connection between the terminals 160a,b of the electrode power supply 114 and the electrodes 106,108 of the first electrochemical cell 102 wherein the voltage polarity of the connection is a positive voltage polarity. The polarity selector 348 can also be used to provide a connection between the output terminals 160a,b of the electrode power supply 114 and the electrodes 106,108 of the second electrochemical cell 102b wherein the voltage polarity of the connection is a negative voltage polarity.

The polarity selector 348 optionally comprises a relay. For example, in one embodiment, the polarity selector 348 can comprise a double-pole double-throw relay 97. The double-pole double-throw relay 97 can be used to select the polarity of the output of the electrode voltage supply 114 at the output terminals 160. The double-pole double-throw relay breaks the circuit before making the circuit, thereby protecting against shorts. When the output terminals 160a, 160b are connected to the electrodes 106, 108 respectively, the relay 97 controls the polarity of the voltage applied to the electrodes as follows: When the relay 97 of the polarity selector 348 is in position 1, the positive terminal is connected to the inner electrode 106 and the negative terminal is connected to the outer electrode 108. When the relay 97 of the polarity selector 348 is in position 2, the positive terminal is connected to the outer electrode 108 and the negative terminal is connected to the inner electrode 106. The polarity selector 348 is activated by the polarity control input.

In one version, the electrode power supply 114 is configured to be controlled by a controller such as the microcontroller 152. For example, the control input and the polarity control input are optionally provided at least in part by the microcontroller 152. In such a version, the voltage selector 320 and the polarity selector 348 are configured to be capable of being connected to the microcontroller 152 to receive the control input signal and the polarity control input signal, respectively, from the microcontroller 152. The microcontroller 152 generates at least one of the control input signal or the polarity selection signal based on at least one of: an input received from a user, or data stored in a memory accessible by the microcontroller 152. In one embodiment, the zero-crossing detector 336 is configured to be connected to the microcontroller 152. For example, the zero-crossing detector 336 is optionally configured to provide the indication signal to the microcontroller 152, which can then generate the control input signal provided to the voltage selector 320 at least in part based on the indication signal.

The ion exchange apparatus 100 may comprise a plurality of fluid treatment cells 102 and a plurality of electrode power supplies 114. In one version, shown in FIG. 3, the ion exchange apparatus 100 has two electrochemical treatment cells 102a,b, two power supplies 114a,b and a valve system 118. The electrochemical cells 102a,b, power supplies 114a,b and valve system 118 are controlled by a controller 132. Each of the power supplies 114a,b independently comprises necessary components, for example, the components shown in the embodiment illustrated in FIGS. 5 and 6. However, in another version, the power supplies 114a,b may have certain components in common, for example, they may share a single zero-crossing detector 336, as the zero-crossing signal generated by the zero-crossing detector 336 is dependent only upon the AC voltage, and thus may be commonly used by a plurality of power supplies.

While a single power supply 114 can also be used, the dual power supply 114a,b allows one power supply 114a to operate the first cell 102a for both deionization and regeneration, and the other power supply 114b to operate the other cell 102b also for both functions. This way both cells 102a,b can be operated independently or simultaneously. The power supplies 114a,b each have two output terminals 157a,b and 153a,b. In this version, each power supply 114a,b is connected to a single cell 102a,b, respectively, for example, the power supply 114a is connected to cell 102a and power supply 114b is connected to cell 102b. The level of the voltage output between the terminals 157a,b and 153a,b is controlled by the controller 132. Each power supply 114a,b is capable of providing a bias voltage to each of the cells 102a,b respectively, to operate the connected cell for fluid treatment or regeneration. In the version shown, each power supply 114a,b is capable of outputting a voltage from between about −300 volts and +300 volts. For example, the power supplies 114a,b can output a positive voltage of up to about 300 volts and a negative voltage less than about −300 volts, between the output terminals 157a,b and 153a,b.

In yet another version, the dual power supply 114a,b is set up so that the polarity of each of the power supplies 114a,b is a fixed polarity so that one power supply always provides a voltage with a positive polarity, and the other a negative polarity. Thus, the first power supply 114a comprises a first output terminal 157a having an always positive polarity, and the second power supply 114b comprises a first output terminal 153a having an always negative polarity. This version allows a first power supply 114a to be used solely for deionization of fluid in both of the cells 102a,b, and a second power supply 114b only for regeneration of both cells 102a,b.

In a further version, each power supply 114a,b is independently connected to both cell 102a and cell 102b, and can be used to drive either cell 102a,b in the deionization or regeneration mode. This version provides duplicate capabilities and is especially useful if one of the power supplies 114a,b fails, as the other power supply can be used to operate both cells 102a,b. In this version, power source 213 comprises additional switches, such as additional polarity selector components, and the controller 132 comprises program code to detect operation (or failure) of each of the power supplies 114a,b and can operate the switches to substitute one power supply for the other as needed.

In operation, the controller 132 controls the power supplies 102a,b for switching them on and off, and controls the supply voltage provided between the output terminals 157a,b and 153a,b. In addition, the controller 132 controls a valve system 118 to regulate the flow of fluid through the cells 102a,b, while controlling the connection to, and voltage supplied at, the terminals 152a,b and 153a,b of each of the power supplies 11 4a,b. In this way, the controller 132 is able to operate the cells 102a,b for fluid treatment, and also to operate one cell 102 in the fluid treatment direction while the other cell 102 is being regenerated.

The apparatus 100 further comprises a fluid piping system which has a first fork 163 that splits into two pipes to allow the incoming fluid stream 124 to flow along one side of the fork toward a first cell 102a, and another side of the fork towards cell 102b. In one version, the valve system 118 comprises four solenoid valves 119a-d which are provided in the piping system to control the flow of fluid through the various pipes. The first pair of solenoid valves 119a,b is positioned in the pipe between the first fork 163 and each of the treatment cells 102a,b to control incoming fluid flow to each of the treatment cells 102a,b. Between the first valve 119a,b and the cell 102a,b, respectively, is second fork 165a,b. At the second fork 165a, fluid flowing through the apparatus 100 can flow to the treatment cell 102a or to the drain 190. Between the second fork 165a,b and the drain 190 is a second solenoid 119c,d, which controls fluid flow to the drain 190. The valve system is controlled by a controller 140 which operates the valves in conjunction with the power supplies 114a,b to treat fluid and regenerate the cells 102a,b.

During operation of cell 102a for fluid treatment, valve 119b is shut and valve 119a is open. Fluid flows from the outlet of the sediment filter 181, through valve 119a and into cell 102a through the first orifice 146a. A forward voltage is applied to the electrodes 106a, 108a of cell 102a and fluid passing through the cell 102a is treated. Fluid exits cell 102a through the second orifice 148a. The dispensing device 128 is opened and treated fluid passes out of the system output 162.

The cells 102a,b, solenoids valves 119a-d and outputs 148a,b arranged in the configuration shown allows for the cells 102a,b to be used to regenerate each other, for example as follows: During operation of cell 102a in the treatment mode and operation of cell 102b in the regeneration mode, valve 119b is shut and valve 119a is open. Valve 119c is shut and valve 119d is open. Fluid flows from the outlet of the sediment filter 181, through valve 119a and through the first orifice 146 of cell 102a . Voltage is applied between the electrodes 106,108 of cell 102a and fluid passing through the cell 102a is treated. Fluid exits cell 102a through the second orifice 148a. Dispensing device 128 is shut, thereby blocking the flow of treated fluid to the output 162. Instead, the fluid flows into cell 102b through the second orifice 148b. A reverse voltage is applied to the electrodes 106, 108 of cell 102b. Fluid flows from the second orifice 148b of cell 102b to the first orifice 146b of cell 102b and picks up ions. Re-ionized fluid exits the first orifice 146b of cell 102b, flows through valve 119c and to the drain 190, where it exits the ion exchange apparatus 100. Fluid passed through cell 102b in this manner rinses the cell 102b of impurities and can be said to recharge the cell 102b for future fluid treatment use. Another version of the valve system 118 can also have five solenoids valves 119, as shown, which are used to control the flow of fluid through the cells 102a,b, to a drain 190, and to a fluid output which outputs treated fluid for a user.

Various other components can be added to the apparatus to improve fluid treatment and cell operations. For example, a fluid flow sensor 204 can be positioned along the fluid stream 125 to measure fluid flow rates. A suitable sensor is a Hall Effect sensor which outputs a voltage which oscillates with a frequency that corresponds to the rotational frequency of a turbine placed in the fluid stream (not shown). A pressure sensor 159 can also be provided to output a fluid pressure signal to the controller 132. The apparatus 100 can also include a sediment filter 181 that serves to filter out particulates from the fluid stream 124. The apparatus 100 can further include an activated carbon filter 187 that sits in the common output pipe 151 and treated fluid passes through the activated carbon filter 187 on the way to the output 162. The apparatus 100 can also include an ultraviolet antimicrobial filter 161 in the fluid stream 125 between the flow pressure sensor 159 and the dispensing device 128.

In one embodiment, the polarity selector 348 is capable of selectively connecting, optionally at the same time, the regeneration electrode power supply to one of a plurality of electrochemical ion exchange cells 102, and the re-ionization power supply to a different one of the plurality of electrochemical ion exchange cells 102.

In one version the power supply 136 comprises a plurality of electrode power supplies 114. For example, in a version of the ion exchange apparatus 100 comprising two electrochemical fluid treatment cells 102a,b, the power supply 136 may comprise two electrode power supplies (not shown) each electrode power supply 114 capable of generating a DC voltage having a selectable voltage level and polarity for a pair of electrodes 106,108 in one of the electrochemical ion exchange cells 102. In one version, each electrode power supply 114 independently comprises necessary components, for example, the components shown in the embodiment illustrated in FIGS. 4 and 5. However, in another version, a plurality of electrode power supplies 114 may have certain components in common. For example, a power supply 136 comprising a plurality of electrode power supplies 114 may have only a single zero-crossing detector 268, as the zero-crossing signal generated by the zero-crossing detector 268 is dependent only upon the AC voltage, and thus may be commonly used by each of the plurality of electrode power supplies 114.

In one version, the power supply 136 also comprises one or more supplemental power supplies 98. In one version, the supplemental power supply 98 is capable of generating a supplemental DC voltage to deliver power to components of the ion exchange apparatus 100 other than the electrodes 106,108. In one version, the supplemental power supply 98 is capable of generating the supplemental DC voltage having a voltage level of from about 1 Volts to about 30 Volts, for example, the supplemental power supply may comprise a DC rectified voltage supply 99a to generate 5 Volts to power the microprocessor of the controller 132. Another power supply 99b generating a different, non-adjustable voltage of, for example, about 12 Volts can be used to power the electric motor 128 or solenoids 119 of the valve system 118. The microprocessor power supply should have a low voltage ripple of less than about 0.1 Volts. One version of the supplemental power supply 98 comprises a transformer, a bridge rectifier, at least one capacitor, and a voltage regulator.

The ion exchange apparatus 100 typically comprises one or more sensors to sense a property of a component of the apparatus 100. The sensor may detect an event or measure a property. For example, the sensor may be a position sensor that senses the position of the rotor in the valve 116 or detects the arrival of the rotor at a certain position. In another example, the sensor may be a conductivity ion sensor that measures directly or indirectly the concentration of ions in the fluid being treated by the ion exchange apparatus 100. The sensor may be placed at certain points in the fluid stream such as, for example, at the inlet 32 or outlet 36 of the electrochemical ion exchange cell 102, or at a combination of these locations or others. The sensor can be also temperature or valve position sensors.

The controller 132 receives signals from the sensors and may use these signals to generate control signals for the power supply 114, such as the voltage selection signal. For example, the microcontroller 152 may generate a voltage selection signal that is in relation to signals from the power supply 136, such as the current detection signal, and a signal from the sensor, such as an ion concentration signal. In another example, the microcontroller 152 may also generate the polarity selection signal in response to signals from the sensor. In another version, the controller 132 may use a combination of signals, such as those generated by the power supply 114 and the sensor, to generate a series of control signals for the power supply 114. For example, the controller 132 may generate a voltage selection signal and a polarity selection signal that evolve in time in response to conditions in the apparatus 100 sensed by the sensor and conditions in the power supply 114 or the apparatus 100 communicated by the power supply 114 to the controller 132, for example communicated by the current detection signal.

The present invention has been described with reference to certain preferred versions thereof; however, other versions are possible. For example, the power supply 136 can be used in other types of applications, as would be apparent to one of ordinary skill, such as to power a motorized tap to control the water or fluid output. Also, the various components of the power supply 136 described to illustrate an exemplary power supply can be substituted by other equivalent components as would be apparent to those of ordinary skill in the art. Therefore, the spirit and scope of the appended claims should not be limited to the description of the preferred versions contained herein.

What is claimed is

1. An electrode power supply for an electrochemical ion exchange cell having an ion exchange membrane between a pair of electrodes, the electrode power supply comprising:
a zero crossing detector to detect zero-crossing events in an AC voltage and produce an indication related to the zero-crossing events,
a voltage selector to receive the AC voltage and selectively couple the AC voltage to a voltage supply such that the selective coupling is enabled based on the indication of the zero-crossing events; and
the voltage supply to receive the selectively coupled AC voltage and generate an output voltage.

2. The electrode power supply of claim 1 wherein the voltage supply rectifies the AC voltage to produce the output voltage.

3. The electrode power supply of claim 2 wherein the output voltage comprises an AC component and a non-zero DC component.

4. The electrode power supply of claim 1 further comprising a pair of output terminals, and wherein the output voltage is provided between the output terminals when the voltage selector couples the AC voltage to the voltage supply.

5. The electrode power supply of claim 1 further comprising a pair of output terminals, and wherein one of the output terminals is electrically connected to ground and the other output terminal receives an output voltage from the voltage supply.

6. The electrode power supply of claim 4 wherein when the voltage selector does not couple the AC voltage to the voltage supply, the voltage at each output terminal comprises at least one of:
(i) a substantially zero voltage with respect to ground; or
(ii) a non-zero floating voltage with respect to ground.

7. The electrode power supply of claim 1 wherein the voltage selector couples the AC voltage to the voltage supply in response to a received control input.

8. The electrode power supply of claim 1 wherein the selective coupling of the voltage selector is enabled based on a comparison of a voltage level of an indication signal, produced by the zero-crossing detector, with a predetermined voltage level.

9. The electrode power supply of claim 8 wherein the indication signal comprises one of:
(a) a relatively high voltage level when there is no zero-crossing event in the AC voltage and a relatively low voltage level when there is a zero-crossing event in the AC voltage, or
(b) a relatively low voltage level when there is no zero-crossing event in the AC voltage and a relatively high voltage level when there is a zero-crossing event in the AC voltage.

10. The electrode power supply of claim 1 wherein at least one of:
(a) the electrode power supply comprises an output terminal, and when the AC voltage is coupled to the voltage supply, the output voltage produced from the AC voltage is supplied between the output terminal and a ground; or
(b) the electrode power supply comprises a pair of output terminals, and when the AC voltage is coupled to the voltage supply, the output voltage produced from the AC voltage is supplied between the pair of output terminals.

11. The electrode power supply of claim 1 further comprising a plurality of output terminals and a polarity selector to select the polarity of the output voltage.

12. The electrode power supply of claim 11 wherein the polarity selector selects the polarity of the output voltage in response to a received polarity control input.

13. The electrode power supply of claim 1 wherein the electrode power supply does not include;
(i) a capacitor; or
(ii) a transformer.

14. An electrode power supply for an electrochemical ion exchange cell having an ion exchange membrane between a pair of electrodes, the electrode power supply comprising:
a relay to receive an AC voltage and selectively couple the AC voltage to a diode-bridge full-wave rectifier;
the diode-bridge full-wave rectifier to produce a full-wave rectified voltage from the AC voltage;
a zero crossing detector to detect zero-crossing events in the AC voltage and produce an indication related to the zero-crossing events; and
an output terminal,
wherein the relay receives a control input signal to control the selective coupling of the AC voltage to the diode-bridge full-wave rectifier, and wherein the relay is enabled to perform the selective coupling based at least in part on the indication.

15. The electrode power supply of claim 14 wherein the diode-bridge full wave rectifier has an output that is electrically connected to an output terminal of the electrode power supply when the electrode power supply is in the on state.

16. The electrode power supply of claim 14 wherein at least one of:
the relay is a single-pole single-throw relay, or
the relay is a double-pole single-throw relay.

17. The electrode power supply of claim 14 wherein the zero-crossing detector comprises a transistor and a diode.

18. The electrode power supply of claim 14 wherein the zero-crossing detector is integrated with the relay into a single discrete component.

19. The electrode power supply of claim 14 wherein the zero-crossing detector and the relay are configured to be capable of being connected to a microcontroller, the zero-crossing detector being configured to provide an indication signal in a format usable by the microcontroller, and the relay being configured to receive the control input signal from the microcontroller.

20. The electrode power supply of claim 19 comprising the microcontroller.

21. The electrode power supply of claim 20 wherein the microcontroller generates the control input signal based on the indication signal received from the zero-crossing detector and at least one of: an input received from a user, or data stored in a memory accessible by the microcontroller.

22. An ion exchange apparatus comprising:
(a) an electrochemical ion exchange cell comprising a fluid channel having an inlet and an outlet, a pair of electrodes, and a water-splitting ion exchange membrane about the fluid channel and between the electrodes; and
(b) an electrode power supply comprising:
(i) a relay to receive an AC voltage and selectively couple the AC voltage to a diode-bridge full-wave rectifier;
(ii) the diode-bridge full-wave rectifier to produce a full-wave rectified voltage from the AC voltage;
(iii) a zero crossing detector to detect zero-crossing events in the AC voltage and produce an indication related to the zero-crossing events; and
(iv) a pair of output terminals,
wherein the relay receives a control input signal to selectively couple the AC voltage to the diode-bridge full-wave rectifier, and the relay is enabled to perform the selective coupling at least in part based on the indication; and
(c) a polarity selector to select a polarity of the full-wave rectified voltage produced between the output terminals of the electrode power supply.

23. The ion exchange apparatus of claim 22 wherein the polarity selector is capable of switching the polarity of the voltage provided between the output terminals of the power supply.

24. The ion exchange apparatus of claim 22 comprising two of the electrochemical ion exchange cells wherein the electrode power supply is a deionization electrode power supply and the ion exchange apparatus further comprises a regeneration electrode power supply.

25. The ion exchange apparatus of claim 24 wherein the polarity selector selectively couples:
the output voltage of the first electrode power supply to regenerate one of the two electrochemical ion exchange cells, and
the output voltage of the second electrode power supply to enable deionization within the second electrochemical ion exchange cell.

26. The ion exchange apparatus of claim 24 wherein the regeneration power supply comprises:
a) a DC voltage supply capable of producing a DC voltage having selectable voltage levels from the AC voltage;
b) a current detector to detect the current level of the DC voltage at a second output terminal; and
c) a voltage selector to select the voltage level of the DC voltage in relation to the detected current level.
